(19) United States
(12) Patent Application Publication
(10) Pub. No.: US 2004/0236631 A1
(43) Pub. Date: Nov. 25, 2004

(54) Single point of entry collection system

(76) Inventor: Roger D. Graham, Southlake, TX (US)

Correspondence Address: DUNLAP, CODDING & ROGERS P.C., PO BOX 16370, OKLAHOMA CITY, OK, 73113, US

(21) Appl. No.: 10/797,167

(22) Filed: Mar. 10, 2004

Related U.S. Application Data
(60) Provisional application No. 60/453,175, filed on Mar. 10, 2003.

(51) Int. Cl. G06F 17/60

(52) U.S. Cl. 705/17; 705/39

(57) ABSTRACT

An information collection system for capturing demographic data from customers that conduct business transactions with cash. The information collection system includes a bill reader and a data collector. The bill reader is capable of selectively receiving from a customer a unique identification code from a bill. The unique identification code identifies customer information. The bill reader transmits the unique identification code identifying customer information for at least one of signaling bill payment to a biller and providing collectable customer data to the data collector. The data collector is operatively associated with the bill reader. The data collector is capable of receiving, transmitting, and storing the customer information from the unique identification code.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates generally to information collection systems, and more particularly, but not by way of limitation, to an improved process for collecting demographic information from bills paid to a third party by customers in a cash transaction at a point of sale.

### BRIEF DESCRIPTION OF RELATED ART

The collection of information from customer transactions is not a new undertaking. Companies historically have collected customer and demographic information from customer credit card transactions so as to develop a pattern of customer buying habits.

However, many customers do not have credit cards, thus there is a large percentage of paying customers for which demographic information is not available. Though many customers may desire electronic transactions, other customers desire, or are required to transact business in cash. This makes it more difficult to obtain demographic information from cash paying customers.

Thus, a need exists for a method and apparatus that enables companies to acquire demographic information from customers that pay for products in cash.

### BRIEF DESCRIPTION OF THE DRAWINGS

FIG. 1 is a diagrammatic representation of an information collection system with data capture at a third party terminal according to an embodiment of the present invention.

FIG. 2 is a diagrammatic representation of a bill reader used with the present invention.

FIG. 3 is a diagrammatic representation of a data collector used with the present invention.

FIG. 4 is a diagrammatic representation of a printed bill used with the present invention.

FIG. 5 is a schematic representation of the process followed in accordance with the present invention for causing payment of the bill from a bank associated with a third party to a bank associated with a biller.

### DETAILED DESCRIPTION OF THE INVENTION

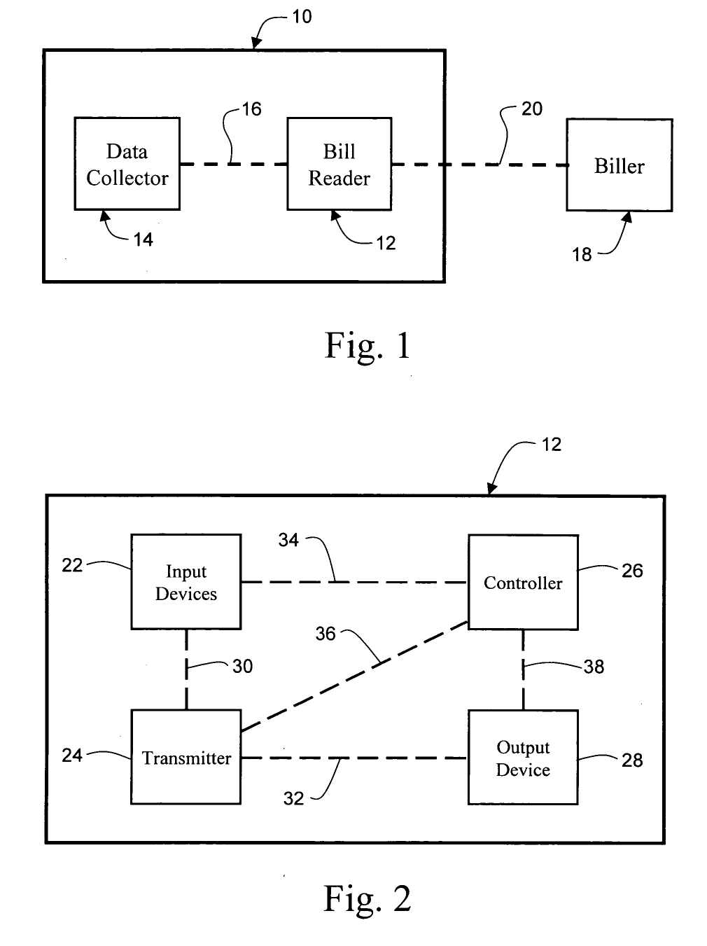

Referring now to FIG. 1, a single point of entry collection system 10 is shown constructed in accordance with the present invention. The collection system 10 includes a bill reader 12 and a data collector 14. The bill reader 12 and the data collector 14 can be provided at the same location or at remote locations. The collection system 10 may be utilized at a point of sale; however, it should be understood that the collection system 10 may be utilized in various ways in accordance with the present invention.

The bill reader 12 is adapted to communicate with the data collector 14 via signal path 16. The bill reader 12 also communicates with a biller 18 via signal path 20. The signal paths 16 and 20 can be airway and/or cable communication links or any other suitable communication link, such as hard wiring (copper wiring, fiber optics, coaxial cable, or the like), RF wireless (microwave, low frequency, satellite, or the like) and/or optical (laser, infrared, or the like).

As shown in FIG. 2, the bill reader 12 has an input device 22, a transmitter/receiver 24, a controller 26, and an output device 28. The input device 22 is capable of reading a bill code provided on a bill, either manually or electronically. The bill code is either representative of demographic data or linked to demographic data.

The input device 22 can be an optical reader into which a bill having a bar code is slid for data capture. Alternatively, a hand-held reader, barcode wand, flatbed scanner or facsimile engine could be used. A magnetic strip reader can also be used which reads a magnetically encoded strip on the bill. Alternatively, the strip could be replaced with MICR encoded data and, in this case, the input device 22 will be the optical reader.

The transmitter/receiver 24 receives the bill code data via a signal path 30 from the input device 22. The transmitter/receiver 24 transmits the bill code data to the output device 28 via a signal path 32.

The controller 26 controls any input or output data by controlling the input device 22, output device 24, and transmitter 28 via respective signal paths 34, 36, and 38. The controller 26 can be a Central Processing Unit (CPU) or any digital or analog device that controls the input or output of data.

The signal paths 30, 32, 34, 36, and 38 can be hard wiring (copper wiring, fiber optics, coaxial cable, or the like), RF wireless (microwave, low frequency, satellite, or the like) and/or optical (laser, infrared, or the like).

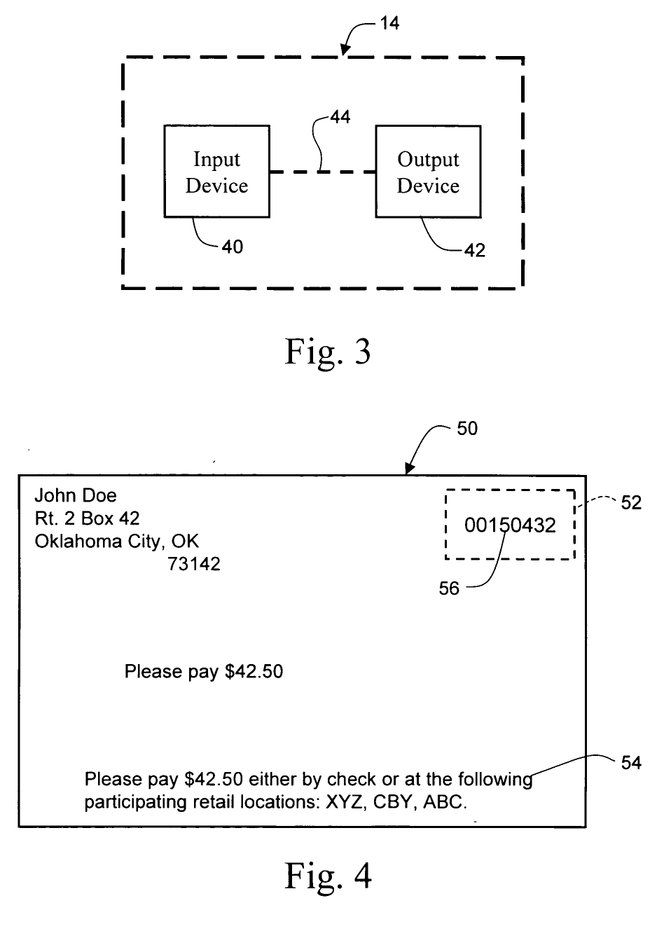

Referring to FIGS. 1 and 3, the data collector 14 is shown having an input device 40 and an output device 42. The input device 40 receives the bill code data from the bill reader 12 via the signal path 16. The input device 40 and the output device 42 communicate via the signal path 44. The data collector 14 stores the bill code data in a database specified by the single point of entry system 10. The bill code data is retrieved by the output device 42 and utilized as demographic information by the retail store.

Referring to FIGS. 1 and 4, in use, the biller 18 sends a bill 50 having specific information encoded in an encoding region 52 by post mail or electronic mail to a customer. Such information that may be encoded in the encoding region 52 may include: an identifying number assigned by the single point of entry collection system 10, an identifying customer number assigned by the biller, the exact amount of the bill being paid, the due date of the bill being paid, the grace period, if any, for late payment, and the exact amount of the penalty, if any, for late payment may be encoded in the encoding region.

However, the type of information to be collected from the biller 18 may vary depending on the biller 18. For example, if the biller 18 is an auto insurance company, the information could include: name, address, age, sex, marital status, number of drivers in household an their ages, driver's license number, and number and type of vehicles driven and their mileage.

The biller 18 can include on the bill 50 the names of the third party retail stores 54, such as Wal-mart, Target, or the like, which are equipped with the bill reader 12, so that the customer can pay for the bill 50 by any suitable payment medium, such as cash, check, or credit card. The retail stores 54 will be licensed as agents which will enable the retail stores 54 to accept payment in cash or other payment medium for the benefit of the biller 18. The single point of entry collection system 10 can track the payment and have the retail stores 54 disallow payment in the event a biller 18 specifically wants payment stopped.

The customer travels to one of the selected retail stores 54 listed on the bill 50. While paying the bill 50 in cash, the customer will also have the opportunity to make purchases from the retail store 54.

A point of sale terminal located at the retail store 54 will include the bill reader 12. The bill reader 12 captures the data needed from a bill code 56 located on the bill 50 to electronically generate a bill pay order 58.

The bill reader 12 transmits certain data from the bill code 56 to the data collector 14 via the signal path 16 so as to store demographic information. The bill code 56 may include such information as: an identifying number assigned by the single point of entry collection system 10, an identifying customer number assigned by the biller, the exact amount of the bill being paid, the due date of the bill being paid, the grace period, if any, for late payment, and the exact amount of the penalty, if any, for late payment, depending on the type of bill being paid. Having the due date and grace period in the bill code 56 enables the ret-ail store 54 to accept payment, if the bill 50 is presented and paid before the due date, or within the grace period. Otherwise, the payment is not accepted by the retail store 54 and the customer must deal directly with the biller 18.

It should be understood that depending on the biller 18, any customer information, so desired by the biller 18, may be included in the bill code 56.

The single point of entry collection system 10 assimilates the information available from the biller 18, thus, recording the bills and the purchases paid at the retail store 54. The single point of entry collection system 10 profiles persons based on the information of what is purchased. The single point of entry collection system 10 provides the retail store 54 with the collected information from the bill code 56, so that the retail store 54 can develop a pattern of customer buying habits.

Information can be captured on a system at the retail store 54 and then transferred periodically to the single point of entry collection system 10. The single point of entry collection system 10 can be organized to function directly with the retail store system, connected to the retail store at a remote location via a wireless system, or combinations thereof.

In other words, the type of information collected from the files of the biller 18 will vary from party to party. The system 10 is designed to work for any type of payment, such as periodic payments (rent, utilities, etc.) By piecing information together and collecting it utilizing the unique number or code assigned by the system 10, the system 10 develops a profile of the buying habits of each individual cash customer.

Thus, when the cash customer goes to the retail store 54 and pays his bill, the system 10 will record the bill(s) paid and, in addition, the purchases made at the retail store 54; for example, the brand of toothpaste. Then, the system 10 will be able to profile the age, etc. of people that buy that brand of toothpaste.

Thus, it is envisioned that the third party, such as the retail store 54, for example, will conduct at least two business transactions with the customer. Each of the business transactions includes the purchase by the customer of at least one item, and payment by the customer of the bill 50 provided to the customer by the biller 18. Each of the bills is separate from one another in each business transaction (e.g., one of the bills 50 is a September bill and another one of the bills is an October bill). Each of the business transactions includes the step of reading the bill code 56 from one of the bills with the bill codes 56 on the separate bills each identifying customer information. An identification of the item purchased and the customer information or identification of the customer is stored in each transaction. A profile of the business transactions of the cash-paying customer based on the stored identifications of the items purchased is then provided.

The data collector 14 could be a database or any other storage and retrievable media. Demographic information is accumulated concerning the habits, timing, and trends of cash-paying customers, to be retrieved by the retail store.

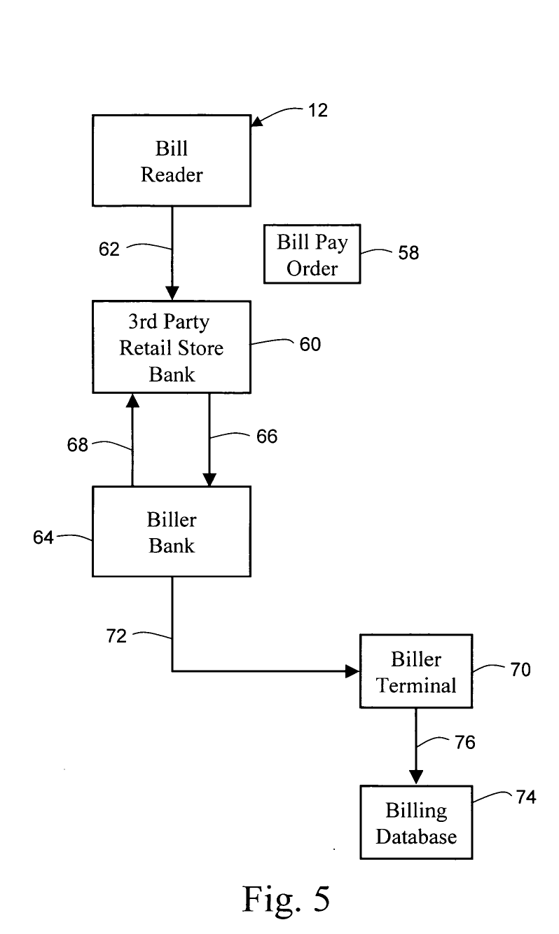

As shown in FIG. 5, the bill pay order 58 generated by the bill reader 12 is transmitted to a third party retail store bank 60 via a signal path 62 so that the invoiced amount on the bill 50 can be transferred to a biller bank 64 via signal path 66. The biller bank 64 may be required to acknowledge receipt of payment from the third party bank 60 via signal path 68. The biller bank 64 transmits the required accounts receivable data to a biller terminal 70 via signal path 72, which reads the captured account number from the accounts receivable data and applies a credit to the customer's account in a billing database 74 via signal path 76.

One skilled in the art will recognize that the bill reader 12, in one preferred embodiment, will be a computerized point of sale terminal having instructions including program code stored on a computer readable medium for causing the point of sale terminal to operate as discussed herein. The computer readable medium can be any type of device capable of storing the instructions and permitting the computerized point of sale terminal to read the instructions. For example, the computer readable medium can be a memory (such as Read Only Memory (ROM), Random Access Memory (RAM) or flash memory), a magnetic storage system (e.g., a floppy disk or a hard disk), an optical storage system (e.g., optical disk such as a CD-ROM), a network storage system or the like.

The following example of the operation of the collection system 10 is set forth hereinafter. It is to be understood that the example is for illustrative purposes only and are not to be construed as limiting the scope of the invention as described.

### EXAMPLE 1

The bill reader 12 can be positioned at a point-of-sale terminal provided at a retail location, such as Wal-Mart. A utility company mails a bill 50 having a bill code 56 to a customer for utility services. The customer has no credit card or checking account with which to pay the utility bill. The utility company designates certain retail stores as sites having the ability to accept a cash payment. Wal-Mart happens to be designated as one of the sites.

The customer travels to Wal-mart and shops for a number of items. After shopping, the customer takes his items to a point of sale terminal provided at Wal-mart and checks out. The customer provides his utility bill 50 at the point of sale terminal having the bill reader 12 along with the other items the customer wishes to purchase. The utility bill is scanned by the input device 22 and a bill reading signal, including the bill code 56, is transmitted to the transmitter/receiver 24 via the signal path 30. The transmitter/receiver 24 transmits the bill reading signal via the signal path 32 to the output device 28. The bill reading signal is then transmitted via signal path 16 to the input device 40 of the data collector 14. The data collector 14 stores the bill code 56 and an identication of the products purchased by the customer to produce a profile of the buying habits of the customer.

The customer pays for the items and the bill with cash. Wal-mart's bill reader 12 transmits a bill paying signal to Wal-mart's bank via a signal path. Wal-mart's bank receives the bill paying signal and transmits the amount of the customer's bill via a signal path to the utility company.

### EXAMPLE 2

A customer orders a collection of books from a website on the Internet. The customer can print a document showing details of the purchase. The customer desires to pay cash for the books, so the company sends an invoice to the customer for the books via post mail or e-mail. The invoice contains a bar code having machine readable information and a list of sites in which the customer can pay the invoice in cash.

The customer takes the invoice to a point of sale terminal at a retail store listed on the invoice. The point of sale terminal is equipped with an invoice scanner. The invoice scanner reads the bar code on the invoice and transmits an invoice receiving signal having machine readable information to a data collector via a signal path so that demographic information can be accumulated. The customer pays the invoice with cash.

The invoice scanner located at the retail store transmits an invoice payment signal via a signal path to the company. The company receives the invoice payment signal and transmits an acknowledgment signal to the point of sale terminal. The company ships the collection of books to the customer.

Changes may be made in the combination and arrangement of the elements as heretofore set forth; it being understood that changes may be made in the embodiments disclosed without departing from the spirit and scope of the invention as defined herein.

What is claimed is:

1. A method for capturing demographic data from a customer that conducts business transactions with cash, the method comprising the steps of:
transmitting a bill to a customer from a biller, the bill having a bill code encoded in a readable encoding region, the bill code identifying customer information and a payment amount;
reading the bill code with a bill reader associated with a third party to collect the customer information and the payment amount;
receiving cash by the third party for at least the payment amount; and
causing payment of the bill from a bank associated with the third party to a bank associated with the biller.

2. The method of claim 1, wherein the bill reader is positioned at a point of sale terminal.

3. The method of claim 2, wherein the step of causing payment of the bill is defined further as transmitting a bill pay order to the bank associated with the third party.

4. The method of claim 1 wherein the bill code is linked to demographic customer data, and wherein the step of reading the bill code is defined further as reading the bill code and downloading the demographic customer data via the link identified by the bill code.

5. The method of claim 1, further comprising the step of designating, by the biller, the location of the bill reader as a cash-paying site for the customer.

6. A method for capturing demographic data from a customer that conducts business transactions with cash, the method comprising the steps of:
reading a bill code, by a bill reader associated with a third party, from a bill delivered to the customer from a biller, the bill code identifying customer information and a payment amount,
collecting demographic data, by the third party, from the bill code;
receiving cash by the third party for at least the payment amount; and
causing payment of the bill from a bank associated with the third party to a bank associated with the biller.

7. The method of claim 6, wherein the bill reader is positioned at a point of sale terminal.

8. The method of claim 7, wherein the step of causing payment of the bill is defined further as transmitting a bill pay order to the bank associated with the third party.

9. The method of claim 6, wherein the bill code is linked to demographic customer data, and wherein the step of collecting demographic data is defined further as downloading the demographic customer data via the link identified by the bill code.

10. The method of claim 6, further comprising the step of designating, by the biller, the location of the bill reader as a cash-paying site for the customer.

11. A device for causing a point of sale terminal associated with a third party to collect demographic information associated with a customer from a cash transaction, comprising:
a computer readable medium storing instructions including:
program code for causing the point of sale terminal to read a bill code from a bill delivered to the customer from a biller, the bill code identifying customer information and a payment amount,
program code for causing the point of sale terminal to collect demographic data from the bill code;
program code for causing the point of sale terminal to collect cash for at least the payment amount; and
program code for causing the point of sale terminal to output a bill pay order whereby money is transferred from a bank associated with the third party to a bank associated with the biller.

12. A method for capturing demographic data from a customer that conducts business transactions with cash, the method comprising the steps of:
conducting at least two business transactions with a customer by a third party, each of the business transactions including the purchase by the customer of at least one item, and payment by the customer of a bill provided to the customer by a biller, each of the bills being separate from one another in each business transaction and each of the business transactions including the step of reading a bill code from one of the bills with the bill codes on the separate bills each identifying the customer;
storing an identification of the item purchased and the identification of the customer in each transaction; and
providing a profile of the business transactions of the cash-paying customer based on the stored identifications of the items purchased.
